(19) United States
(12) Patent Application Publication
(10) Pub. No.: US 2012/0204391 A1
(43) Pub. Date: Aug. 16, 2012

(54) VALVE SEAT REMOVAL SOCKET

(76) Inventor: JOSEPH TERRILL LAMURA, Tampa, FL (US)

(21) Appl. No.: 13/028,880

(22) Filed: Feb. 16, 2011

(51) Int. Cl. B23P 19/04

(52) U.S. Cl. 29/221.6

(57) ABSTRACT

An apparatus for removing a valve seat may comprise a body, a socket, and a plurality of slots. The body may have a first end, a second end, and outer side surfaces disposed between the first end and the second end, in which at least a portion of the body fits against at least a portion of an interior portion of the valve seat. The socket may be at the first end of the body. The plurality of slots may be situated on the outer side surfaces of the body, and may run to the second end of the body.

### BACKGROUND OF THE INVENTION

The present invention generally relates to a plumbing tool, and more particularly relates to a socket usable to remove a valve seat from a backflow valve.

Valves are devices that regulate the flow of a fluid through a pipe by opening or obstructing a passageway within the pipe. One common way of regulating the flow is to use a disc as part of the valve that may regulate the flow within the pipe via the disc's positioning.

A valve seat can be a part of the interior body of the valve, which contacts the disc to form a leak-tight seal obstructing the flow within the valve-regulated pipe. Because the valve seat may play a critical role in ensuring that a leak-tight seal may be formed with a disc, the valve seat may need to be periodically replaced when it is worn and thus no longer able to form a leak-tight seal with the disc.

As can be seen, there is a need for a tool to easily remove a valve seat from a valve while minimizing the chances of causing damage to the valve seat or the valve.

### SUMMARY OF THE INVENTION

In one aspect of the present invention, an apparatus for removing a valve seat comprises a body having a first end, a second end, and outer side surfaces disposed between the first end and the second end, wherein at least a portion of the body fits against at least a portion of an interior portion of the valve seat; a socket at the first end the body; and a plurality of slots on the outer side surfaces of the body that run to the second end of the body.

These and other features, aspects and advantages of the present invention will become better understood with reference to the following drawings, description and claims.

### BRIEF DESCRIPTION OF THE DRAWINGS

FIG. 1 shows a side elevation view of a valve seat removal socket in accordance with an embodiment of the present invention;

FIG. 2 shows a top plan view of the valve seat removal socket of FIG. 1;

FIG. 3 shows a bottom view of the valve seat removal socket of FIG. 1.

FIG. 4 shows a side elevation view of the valve seat removal socket of FIG. 1 in use with a backflow valve in accordance with an embodiment of the present invention;

FIG. 5 shows a typical section view of the valve seat removal socket of FIG. 1 in use with the backflow valve of FIG. 4; and

FIG. 6 shows a view of a kit showing different relative sizes of various configurations of the valve seat removal socket of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide valve seat removal sockets that may be used to remove valve seats, such as valve seats within backflow valves. The valve seat removal sockets may be designed to minimize the chances of cross threading or damaging the face of a valve seat.

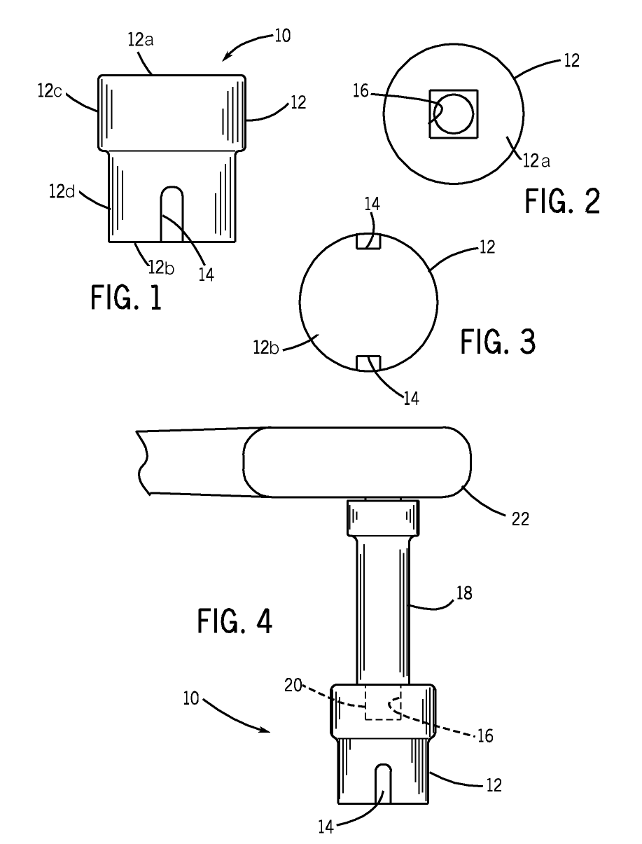

Referring now to FIGS. 1, 2, and 3, a valve seat removal socket 10 may be made of lightweight aluminum or any other suitable materials. The socket 10 may include a body 12 having a first end 12a and a second end 12b. The body may be cylindrically shaped and may include an upper body 12c and a lower body 12d, in which the upper body 12c may have a circumference that is greater than that of the lower body 12d. Because the body 12 may be cylindrically shaped, the first and second ends 12a and 12b may correspondingly be circularly in shape.

The valve seat removal socket 10 may also include a plurality of slots 14 on the lower body 12d that may run to the second end 12b of the body 12. In one exemplary embodiment, the valve seat removal socket 10 has a pair of slots 14 that are on opposite sides of the body 12, although in other exemplary embodiments there may be 4, 6, 8, or any other number of slots on the body 12 as may be necessary.

The valve seat removal socket 10 may also include an opening 16 on the first end 12a of the body 12 that may fit at least a portion of a drive end 20 of an extension drive bar 18 within itself. In an exemplary embodiment, the opening 16 may be a square hole for fitting a square drive end 20, and may be appropriately sized to fit a ¼-inch square drive end 20 or may be appropriately sized to fit a ⅛-inch square drive end 20.

Referring now to FIG. 4, the valve seat removal socket 10 may be used in conjunction with a wrench or ratchet 22 and the extension drive bar 18.

As discussed above, the drive end 20 of the extension drive bar 18 may fit into the opening 16 on the first end 12a of the body 12 of the valve seat removal socket 10. The wrench or ratchet 22 may be operably coupled to the extension drive bar 18 so that a user may use the wrench or ratchet 22 to turn he valve seat removal socket 10 during the course of removing a valve seat or fitting a new valve seat.

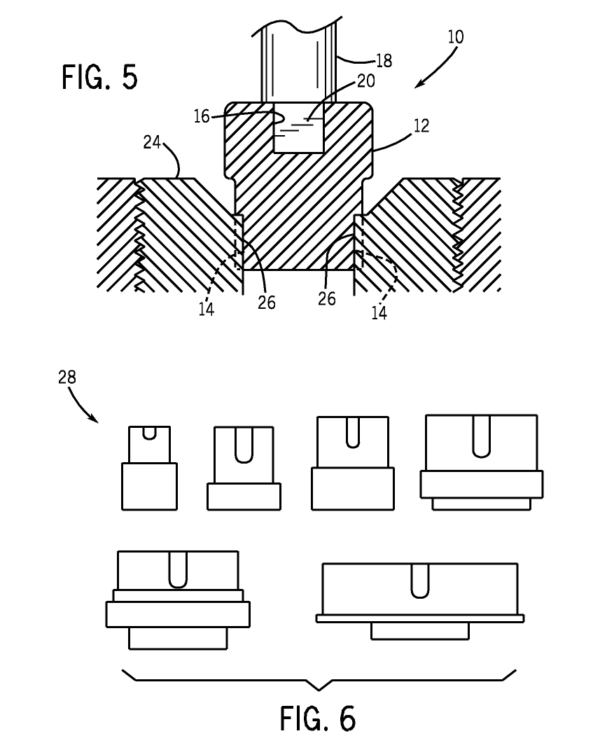

Referring now to FIG. 5, the valve seat removal socket 10 may be used to remove a valve seat 24, such as from a backflow valve. As shown in FIG. 5, the socket 10 may be inserted into the valve seat 24 so that outer side surfaces of the body 12 may contact interior portions of the valve seat 24. Protuberances 26 on the inside of the valve seat 24 may be able to fit into the slots 14 on the body 12 of the valve seat removal socket 10, thus ensuring a snug fit between the valve seat 24 and the socket 10.

The extension drive bar 18 having the drive end 20 that fits into the opening 16 of the socket 10 may be used to remove the valve seat 10. For example, the extension drive bar 18 may be used to turn the socket 10 counterclockwise to remove the valve seat 24. Alternatively, a new valve seat 24 may be installed into a valve my inserting the socket 10 into the valve seat 24, inserting the valve seat 24 into the valve, and using the extension drive bar 18 to turn the socket 10 clockwise to installed the new valve seat 24.

Referring now to FIG. 6, a kit 28 of different size sockets may be provided for use with a variety of different sized valves and valve seats 24.

It should be understood, of course, that the foregoing relates to exemplary embodiments of the invention and that modifications may be made without departing from the spirit and scope of the invention as set forth in the following claims.

We claim:

1. An apparatus for removing a valve seat, comprising:
a body having a first end, a second end, and outer side surfaces disposed between the first end and the second end, wherein at least a portion of the body fits against at least a portion of an interior portion of the valve seat;
an opening at the first end the body; and
a plurality of slots on the outer side surfaces of the body that run to the second end of the body.

2. The apparatus of claim 1, wherein the plurality of slots are operable to accept at least a portion of protuberances interior of the valve seat.

3. The apparatus of claim 1, wherein the outer side surfaces comprise a cylindrical side surface.

4. The apparatus of claim 3, wherein the body is of a cylindrical shape comprising a first cylinder near the first end and a second cylinder near the second end, wherein the first cylinder is of a greater circumference than the second cylinder, and wherein at least a portion of the second cylinder fits against the at least a portion of the interior portion of the valve seat.

5. The apparatus of claim 4, wherein the plurality of slots are situated on the second cylinder of the body.

6. The apparatus of claim 1, wherein the opening is operable to fit at least a portion of a drive end of an extension bar within the opening.

7. The apparatus of claim 6, wherein the drive end of the extension bar comprises a square drive end.

8. The apparatus of claim 7, wherein the square drive end comprises a ¼-inch square drive end.

9. The apparatus of claim 7, wherein the square drive end comprises a ¾-inch square end.

10. The apparatus of claim 1, wherein the plurality of slots comprise a pair of slots.
